(19) United States
(12) Patent Application Publication
(10) Pub. No.: US 2012/0230689 A1
(43) Pub. Date: Sep. 13, 2012

(54) Passive Optical Network Apparatus and Methods

(76) Inventors: Luca Baldini, Roma (IT); Alberto Bianchi, Marina di Pisa (IT); Filippo Ponzini, Pedonia (IT)

(21) Appl. No.: 13/496,485

(22) PCT Filed: Oct. 20, 2009
(86) PCT No.: PCT/EP2009/063716

§ 371 Date: May 26, 2012

(30) Foreign Application Priority Data
Sep. 29, 2009 (EP) 09171553.2

(51) Int. Cl. H04Q 11/00; H04J 14/02

(52) U.S. Cl. 398/48; 29/428

(57) ABSTRACT

A node of a wavelength division multiplexed passive optical network (WDM-PON) comprises wavelength division multiplexing optical line termination (OLT) apparatus. The OLT has an optical interface for interfacing with a plurality of remote optical network units in a passive optical network using a plurality of different wavelength channels (λ). The OLT has a plurality of electrical first ports corresponding to the optical wavelength channels (λ). A plurality of second ports interface with at least two operator networks. An electrical switching matrix interconnects the first ports and the second ports, allowing any operator to access any subscriber in a point-to-point manner. The apparatus at node can be formed as a plurality of modules.

### TECHNICAL FIELD

This invention relates to passive optical network apparatus and methods of installing and upgrading the apparatus.

### BACKGROUND

A Passive Optical Network (PON) is a type of access network of a communications system. A PON typically has a central office at which apparatus called an Optical Line Termination (OLT) interfaces with a metro or carrier network. An arrangement of optical fibres and splitters connect the OLT with multiple Optical Network Units (ONU). In a Fibre To The Home (FTTH) system an ONU is located at a subscriber premises while in a Fibre To The Curb (FTTC) system an ONU is located at a roadside cabinet.

Existing PONs are based on Asynchronous Transfer Mode Passive Optical Network (APON), Broadband PON (BPON), Gigagbit PON (GPON) and Ethernet PON (EPON) technologies as standardised by the International Telecommunications Union (ITU-T) and Institute of Electrical and Electronic Engineers (IEEE). Many of these PON technologies use some form of time division multiple access technique, with the capacity of a wavelength channel being shared in a time-divided manner across multiple ONUs.

More recently, Wavelength Division Multiplexed Passive Optical Networks (WDM PON) have been proposed. A WDM PON supports multiple wavelength channels. A separate wavelength can be allocated for communication between the Optical Network Unit (OLT) and each ONU in the PON.

In open markets, such as Europe, there is a requirement that a subscriber should be able to choose an operator to provide their communications service. This complicates the network equipment that must be provided, as it can require multiple operators to each install OLT equipment at a central office.

### SUMMARY

An aspect of the present invention provides an apparatus for a node of a wavelength division multiplexed optical access network comprising:
wavelength division multiplexing optical line termination apparatus comprising an optical interface for interfacing with a plurality of remote optical network units in a passive optical network using a plurality of wavelength channels, and a plurality of electrical first ports corresponding to the optical wavelength channels;
a plurality of second ports for interfacing with at least two operator networks;
an electrical switching matrix for interconnecting the first ports and the second ports.

Such an apparatus allows a full, physical layer, “unbundling” of the capacity of the wavelength division multiplexed passive optical network (WDM-PON), with a plurality of operators able to access any optical network unit or subscriber in a point-to-point manner. Typically, there will be a single wavelength channel for communication with each optical network unit, or a pair of wavelength channels for communication with each optical network unit.

Advantageously, the wavelength division multiplexing optical line termination apparatus comprises a plurality of optical interfaces, each for interfacing with a plurality of remote optical network units in a different passive optical network using a plurality of wavelength channels, there being a plurality of electrical first ports corresponding to the optical wavelength channels used in each optical interface.

Advantageously, the apparatus is formed as a plurality of modules. Each of the modules comprises a wavelength division multiplexing optical line termination unit which provides one of the optical interfaces and has a plurality of electrical first ports corresponding to the optical wavelength channels used in that optical interface.

Advantageously, each of the modules further comprises an electrical switching matrix unit for interconnecting the first ports of the wavelength division multiplexing optical line termination unit in that module to the second ports.

A modular form of the apparatus allows a “pay as you grow” model, where operators only install as much apparatus as required to serve the number of subscribers requiring service. The optical interface of each module is optically isolated from the optical interface of other modules. This has an advantage of allowing a common set of wavelength channels to be reused in some, or all, of the optical interfaces and reduces the cost of the apparatus.

Each module can be a single physical unit, such as a plug-in card, or a plurality of physical units or cards which are intended to work together to provide the required functionality.

Another aspect of the present invention provides a method of installing an optical access network comprising installing apparatus at a node as defined above and, for each optical network unit of the passive optical network requiring connection, configuring the switching matrix to interconnect a first port, corresponding to an optical wavelength channel used by that optical network unit, and a second port corresponding to a required operator network for that optical network unit.

Another aspect of the present invention provides a method of upgrading an optical access network comprising apparatus at a node as defined above, with the switching matrix configured to interconnect a first port, corresponding an optical wavelength channel used by an optical network unit, and a second port corresponding to a first operator network for that optical network unit, the method comprising reconfiguring the switching matrix to interconnect the said first port, corresponding to the optical wavelength channel used by the optical network unit, and another second port corresponding to a different required operator network for that optical network unit.

### BRIEF DESCRIPTION OF THE DRAWINGS

Embodiments of the invention will be described, by way of example only, with reference to the accompanying drawings in which:

FIG. 1 shows a communications system comprising a central office connected to wavelength division multiplexed passive optical networks (WDM-PON) and metro networks of operators;

FIG. 2 shows the functionality of the central office of FIG. 1 implemented by a set of modules;

FIG. 3 shows an alternative version of FIG. 2 where a module serves multiple PONs;

FIG. 4 shows one of the modules of FIG. 3 in more detail;

FIG. 5 shows steps of a method to configure the central office apparatus to install a new WDM-PON;

FIG. 6 shows steps of a method to configure the central office apparatus to connect an ONU to a different operator network;

FIG. 7 shows steps of a method to configure central office apparatus to connect to a new operator network.

### DETAILED DESCRIPTION

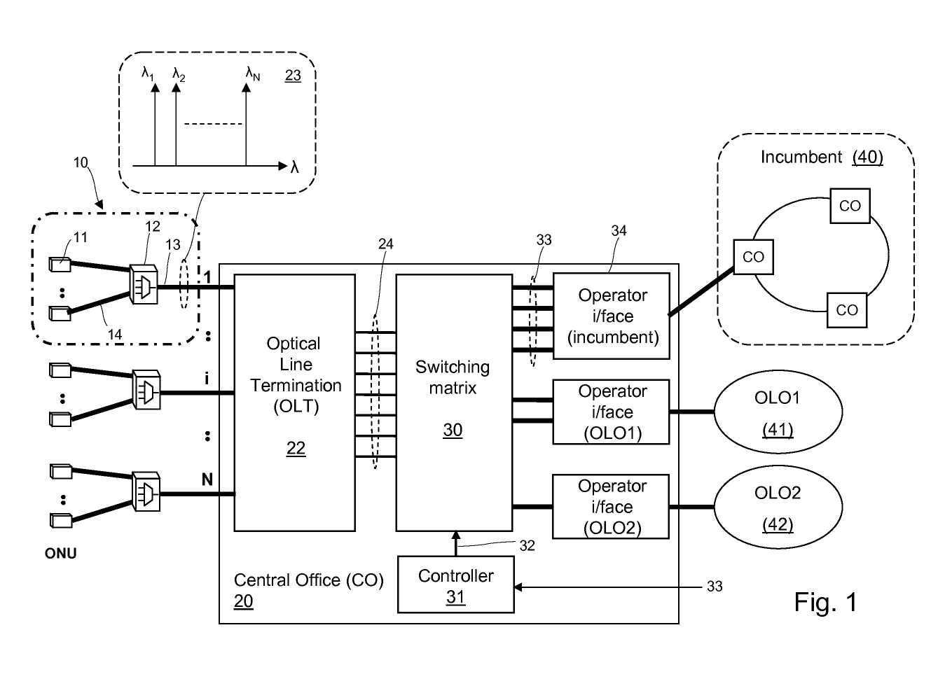

FIG. 1 shows a communications system according to an embodiment of the present invention which comprises a plurality of wavelength division multiplexed passive optical networks (WDM-PON) 10 which together form an optical access network. Each WDM-PON 10 can be used as an access network to serve subscriber premises. The main entities in each WDM-PON are optical line terminations (OLT) 22 at a central office (CO) 20, a distribution node 12 and a plurality of Optical Network Units (ONU) 11. The ONUs are deployed at individual subscriber premises or at kerbside cabinets, depending on the type of PON architecture.

Central office 20 interfaces with metro or core communication networks 40, 41, 42 belonging to different operators. Operators 40-42 are different telco providers who can compete to offer a communications service to subscribers served by the PONs 10. One such network 40 is shown in more detail in FIG. 1. Typically, the first operator 40 is known as the incumbent, and other operators 41, 42 are known as Other Licensed Operators (OLO).

In a wavelength division multiplexed passive optical network (WDM-PON) multiple wavelength channels, called lambdas λ, are allocated for communication between the Central Office 20 and ONUs 11. In an advantageous scheme, a single lambda is allocated for communication between the Central Office 20 and a single ONU 11. A set of wavelength channels are carried between the OLT and remote node 12 on a common fibre 13, and then passively demultiplexed at the remote node 12 onto a set of fibres 14. Each fibre 14 carries a single wavelength channel to an ONU 11. Bi-directional communication can be achieved in various ways, such as by the use of two wavelength channels to each ONU (i.e. one wavelength channel for downstream communication and a different wavelength channel for upstream communication) or by time-division multiplexed use of a single wavelength channel.

OLT 22 supports an optical interface 23 with the set of ONUs 11 in a PON 10. OLT 22 connects to fibre 13 and transmits/receives on a set of optical wavelength channels. Each optical wavelength channel is terminated at the Optical Line Termination unit (OLT) 22 at the CO 20. The OLT 22 also has a set of electrical ports 24. Each port 24 is an input or output path to an individual one of the ONUs 11. Typically, there is a 1:1 relationship between ports 24 and ONUs 11. OLT 22 has an optical transmitter which modulates an optical source using an electrical signal representing data to be transmitted, received from a port 24. The OLT 22 also has an optical receiver which detects a data signal carried by the optical wavelength channel and outputs the data as an electrical signal to a port 24. Typically, data is carried over a wavelength channel by phase, frequency or intensity modulation of an optical source. In FIG. 1 the CO connects to N PONs 10 and supports an optical interface 23 with the set of ONUs in each PON.

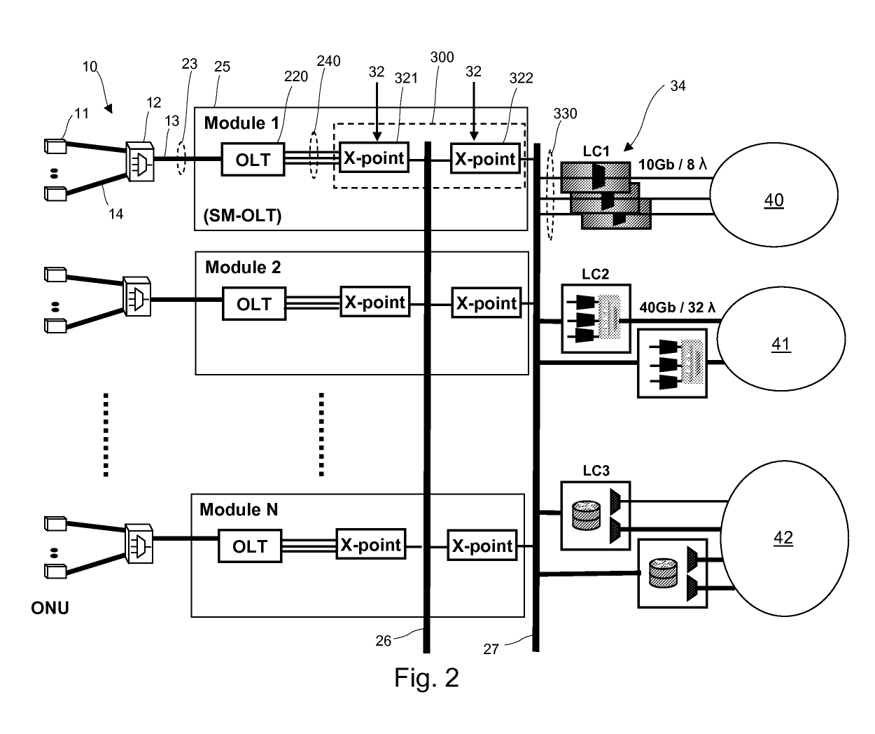

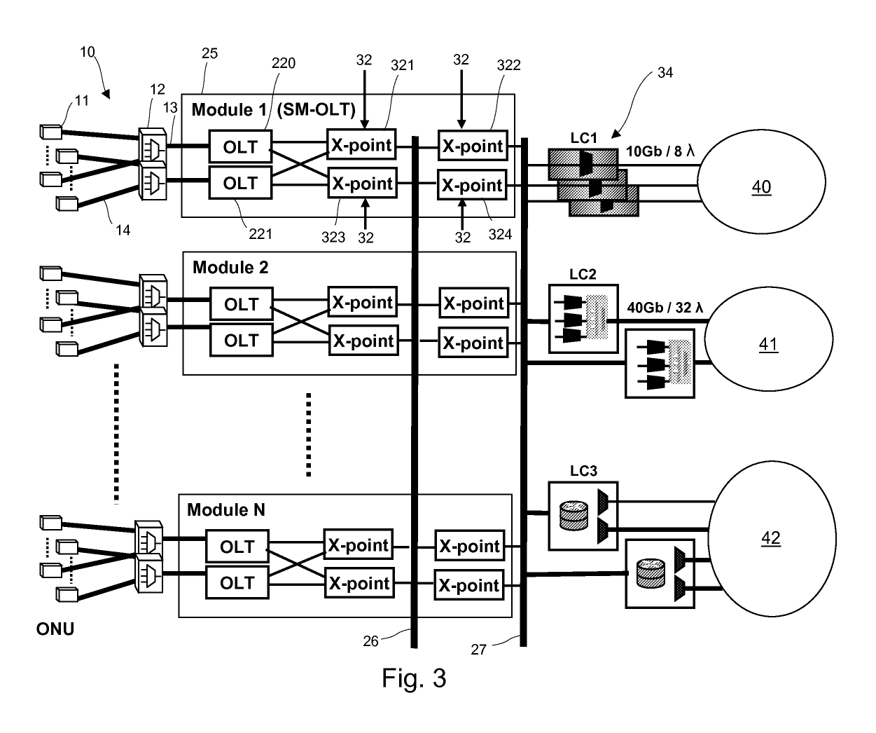

The overall switching matrix 30 of the CO 20 connects to the electrical ports 24 of the OLT 22 and has a set of ports for connecting with each of the operator networks 40-42. The switching matrix 30 allows interconnections between any port 24, representing an individual wavelength channel used by an ONU 11, and any operator network 40-42. The switching matrix 30 routes traffic between a particular operator and all ONUs 11 requiring service from that operator. A set of ports 33 are shown connecting with an interface 34 to the incumbent operator network 40. Another set of ports of switching matrix 30 connect with an interface to the operator OLO1 and a further set of ports of switching matrix 30 connect with an interface to the operator OLO2. The switching matrix 30 can be realised as a single switching stage or, advantageously, as multiple sequential switching stages shown in FIGS. 2 and 3. Switching matrix 30 performs switching of signals between ONUs 11 and operator networks 40-42 in the electrical domain.

A controller 31 configures the switching matrix 30 in response to external input signals 33 which specify what connectivity is required from the CO, e.g. ONUx requires service from OLO1, ONUy requires service from OLO2. Controller 31 outputs control signals 32 to configure the switching matrix to provide the required connectivity.

Interface apparatus 34 is provided for each operator network 40-42. Each operator 40-42 can make an individual decision as to how traffic is carried over their own network 40-42. Typically, an operator will use some form of multiplexing (aggregation) to combine the individual connections to/from for each ONU and may also use concentration (i.e. compression, or bit-rate reduction) to reduce the bit rate of individual connections, or the combined set of connections. Interface apparatus 34 can include apparatus which, in the direction of transport towards the operator network 40, multiplexes traffic (also called aggregation) and, optionally, concentrates traffic (i.e. compresses, or reduces the bit rate of the traffic). Interface apparatus 34 can also include apparatus which, for the direction of transport towards the CO 20, demultiplexes traffic and, optionally, de-concentrates traffic (i.e. decompresses, or increases the bit rate of the traffic). Interface apparatus 34 can be implemented as one or more line cards at the CO 20. An operator can increase the number and/or capacity of the line cards at the CO 20 as an increased number of ONUs 11 require service from that operator.

Traffic can be multiplexed, and optionally concentrated, in different ways in order to meet requirements needed from the incumbent or OLOs 40-42. Examples include:

Multiplex (aggregate) on lambda/user basis and send to the proper operator without any level of concentration. Different aggregation level could be feasible (e.g. 10 Gb links for 8 lambdas/users @1 G, 40 Gb/32 subs).

Multiplex (aggregate) for incumbent operator subscribers. Traffic can also be concentrated in the same node. Such traffic shall be ready to be transported by the incumbent optical packet metro.

Multiplex (aggregate) and also concentrated by the incumbent for a specific OLO. In this way, the OLO shall rely on incumbent transport service to carry its traffic towards the Operator Point of Presence (POP).

FIG. 2 shows an advantageous form of the CO 20, in which the optical line termination functionality 22 and switching matrix functionality 30 is distributed across a set of modules 25. Each module 25 comprises WDM OLT functionality 220 and switching functionality 300. Each WDM PON OLT unit 220 provides the same functionality as the OLT 22 shown in FIG. 1, but only for a set of ONUs served by a single PON 10. The OLT 220 interfaces optically with a fibre 13 and transmits/receives on a set of optical wavelength channels. The OLT unit 220 has an optical transmitter which modulates an optical source using an electrical signal representing data to be transmitted. The OLT unit 220 also has an optical receiver which detects a data signal carried by the optical wavelength channel and outputs the data as an electrical signal. Typically, data is carried over a wavelength channel by phase, frequency or intensity modulation of an optical source. Each module has an OLT unit 22 which has capacity to serve a maximum number of ONUs, e.g. 128. Each OLT unit 22 has a set of electrical ports 240. Each port 240 is an input/output path to an individual one of the ONUs 11. There is a 1:1 relationship between ports 240 and ONUs 11 in the PON 10. Advantageously, OLT 220 has a port 240 for each direction of communication per ONU 11, giving two ports per ONU 11.

The overall switching matrix 30 of the CO 20, shown in FIG. 1, is now distributed across the set of modules 25, there being a switching unit 300 in each module 25. The switching unit 300 in a module 25 can have two sequential switching stages 321, 322. The modular form of the CO apparatus allows the functionality of the CO 20, in terms of OLT apparatus to support the optical interface with ONUs 11, and switching functionality to support the connection of subscribers with an operator, to be upgraded gracefully as additional subscribers are added to the optical network(s) 10. Each switching unit 321, 322 receives a control signal 32 from controller 31 to configure the switching units 321, 322 of the module to implement the required connectivity.

FIG. 2 also shows the modularity of the operator interface apparatus 34, with different interface apparatus 34 provided for each of the operators 40-42.

FIG. 2 shows a set of N modules 25 installed at a CO 20. Electrical switching interfaces, or buses, 26, 27 interconnect the modules 25 and allow signals to be exchanged between individual modules 25. Interface 27 connects with each of the operator network interfaces 34.

The switch in the module 25 is an electrical circuit switch, formed by smaller integrated Strictly Non Blocking (SNB) devices. The problem of rearranging a set of N inputs to a set of N outputs is about finding one of the possible permutations between any input port to any output port. In this scenario we have a group of K undifferentiated outputs, for example associated to an OLO, where for instance the output ports are partitioned taking into account a single OLO (K ports) and an incumbent (N-K ports). In this way the number of possible permutations will substantially decrease based on the partitioning of different OLOs plus the incumbent. It is not request to switch a specific user to a specific output, because it is enough to connect each input to one of the outputs assigned to the proper operator (incumbent or one of the OLO).

FIG. 3 shows an alternative form of the modules 25. Here, each module 25 has a higher capacity and comprises two OLT units 220, 221 which each connect with a PON 10. Additional switching units 323, 324 are provided. As an example, each module 25 can connect to 2×128 ONU PONs, giving a total of 256 served ONUs. The set of wavelength channels used by one of the PONs 10 can be reused by another of the PONs 10 within the same module 25, giving efficient frequency use and allowing the same OLT module to be used for OLT modules 220, 221. The CO 20 can comprise a mix of the different type of modules shown in FIGS. 2 and 3.

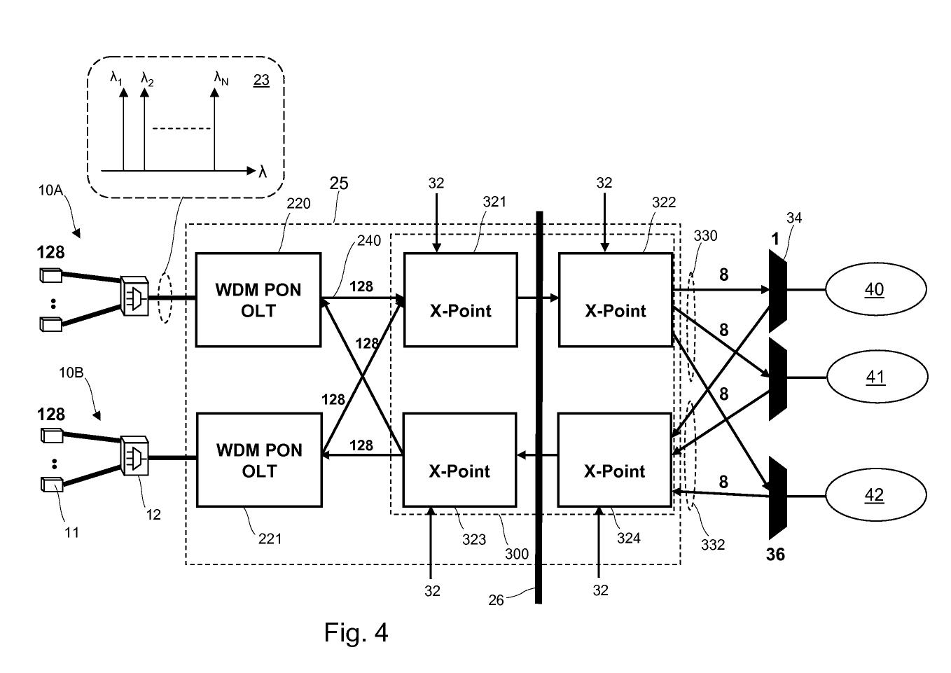

FIG. 4 shows one of the modules 25 of FIG. 3 in more detail. OLT unit 220 is connected to a PON 10A and OLT unit 221 is connected to a PON 10B. Some numerical values are given for illustration purposes, and are not limiting. Each OLT unit has a set of 128 input electrical ports 240 and a set of 128 output electrical ports 240. Here, crosspoint switching units 321, 322 are used to switch signals in the ONU-operator direction and crosspoint switching units 323, 324 are used to switch signals in the operator-ONU direction. FIG. 4 shows a set of output ports 330 which output signals destined for each of the operators 40-42. Similarly, a set of input ports 332 receive input signals from each of the operators 40-42. Each switching unit 321-324 receives a control signal 32 from controller 31 to configure the switching units 321, 322 of the module to implement the required connectivity.

Each module 25 described in the embodiments can be a single physical unit, such as a plug-in card, or a plurality of physical units or cards (e.g. one card carrying the OLT unit 22, one card carrying the switching unit 30), which are intended to work together to provide OLT functionality for a number of ONUs 11 and switching functionality. Advantageously the module, or cards forming the module, are configured to plug in to an equipment rack at a CO 20. Advantageously, the OLT unit 220 comprises a card with optical components which are realised as integrated optics, to reduce the cost and physical size of the module. Even more advantageously, the integration of photonics and electronics (including the possibility of integrating photonic and electronic functions in the same “die”) can permit a single module which is significantly reduced in physical size. As explained above, the architecture presented here allows the same set of wavelength channels to be reused in each of PONs 10A, 10B, thereby allowing each OLT unit 220 to be identical.

The architecture described here provides wavelength unbundling. The possibility to route wavelength channels to various operators with a granularity of a single lambda is guaranteed by a rearrangeably non-blocking switch in order to permit to the operators to provide the requested services also to a small number of users. Each user has a virtual point-to-point wavelength based connection. The architecture also makes it possible to provide different data rates and/or different protocols to individual users, or groups of users (WDM-PON transparency). Each user can have a bandwidth of 1.25 GHz, although different per user bandwidth and port numbers can be applied. The links from the WDM-PON OLT 22, 220 to the switching matrix 30, 300 are purely electrical interfaces. This reduces the complexity and the implementation cost of the switch matrix.

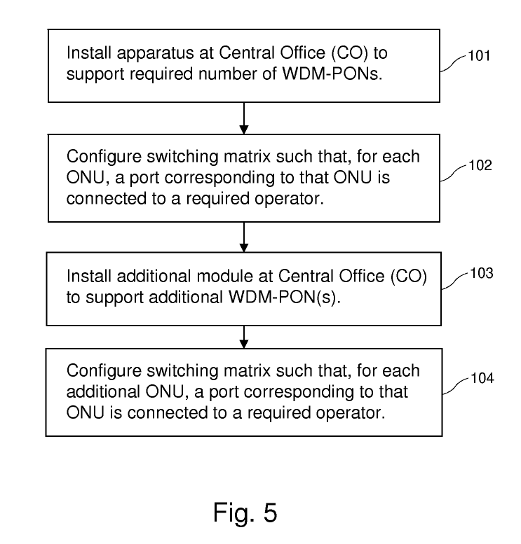

FIG. 5 shows steps of a method to configure the central office (CO) apparatus. Initially, at step 101, apparatus is installed at the CO 20 to support the required number of WDM-PONs 10 and operators. For a modular apparatus 20, this requires installing a number of modules 25 corresponding to the number of WDM-PONs. The switching matrix is configured such that, for each ONU, a port corresponding to that ONU is connected to a required operator. At a later point in time, when further subscribers require service, an additional WDM-PON 10, or WDM-PONs, are required to serve the new subscribers. At step 103 an additional module 25, or modules, are installed at the CO to serve the new subscribers. At step 104 the switching matrix is configured such that, for each new ONU, a port corresponding to that ONU is connected to a required operator. It can be seen that it is only necessary to install an amount of equipment matched to the number of subscribers requiring service, and that additional equipment can be added as required.

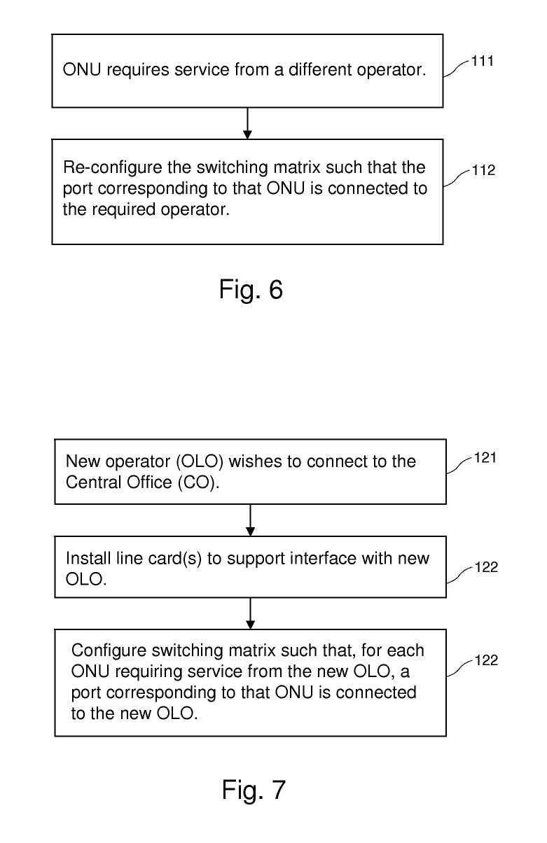

FIG. 6 shows steps of a method to configure the central office apparatus to connect an ONU to a new operator network. It is assumed that a CO has already been configured using steps 101, 102 or 101-104 of the method previously described. At step 111 an ONU requires service from a different operator. For example, a subscriber connected to the ONU may be dissatisfied with the quality, or cost, of the service provided by their current operator. At step 112 the switching matrix is reconfigured such that the port corresponding to that ONU is connected to the new required operator. No additional equipment is required. The reconfiguration of the switch can be made in response to an input 33 specifying the required connectivity, e.g. ONUx requires service from OLO1. Controller 32 translates this request into commands to reconfigure individual switching units within modules 25 to perform the required connectivity.

FIG. 7 shows steps of a method to configure central office apparatus to connect to a new operator network. It is assumed that a CO has already been configured using steps 101, 102 or 101-104 of the method described in FIG. 6. At step 121 a new operator OLO wishes to connect to the CO. At step 122 a new line card, or line cards 34, are installed at the CO to support the interface with the OLO and provide the required multiplexing and concentration of traffic. At step 122 the switching matrix is reconfigured such that the port corresponding to an ONU requiring service from the new OLO is connected to the new required operator. The reconfiguration of the switch can be made in response to an input 33 specifying the required connectivity, e.g. ONUx requires service from OLO1. Controller 32 translates this request into commands to reconfigure individual switching units within modules 25 to perform the required connectivity.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. An apparatus for a node of an optical access network, the apparatus comprising:
wavelength division multiplexing optical line termination apparatus comprising an optical interface for interfacing with a plurality of remote optical network units in a passive optical network using a plurality of wavelength channels, and a plurality of electrical first ports corresponding to the optical wavelength channels;
a plurality of second ports for interfacing with at least two operator networks; and
an electrical switching matrix for interconnecting the first ports and the second ports.

2. The apparatus according to claim 1 wherein the wavelength division multiplexing optical line termination apparatus comprises a plurality of optical interfaces, each for interfacing with a plurality of remote optical network units in a different passive optical network using a plurality of wavelength channels, there being a plurality of electrical first ports corresponding to the optical wavelength channels used in each optical interface.

3. The apparatus according to claim 2 formed as a plurality of modules, wherein each of the modules comprises a wavelength division multiplexing optical line termination unit which provides one of the optical interfaces and has a plurality of electrical first ports corresponding to the optical wavelength channels used in that optical interface.

4. The apparatus according to claim 3 wherein each of the modules further comprises an electrical switching matrix unit for interconnecting the first ports of the wavelength division multiplexing optical line termination unit in that module to the second ports.

5. The apparatus according to claim 4 wherein each of the modules has an input for configuring the switching matrix unit in that module to provide a required connectivity.

6. The apparatus according to claim 4 wherein the electrical switching matrix unit in each of the modules comprises a plurality of switching stages.

7. The apparatus according to claim 4 wherein the electrical switching matrix unit is integrated with the optical line termination unit on a common physical unit.

8. The apparatus according to claim 4 wherein each of the modules has an electrical interface for interfacing the switching matrix unit in that module with a switching matrix unit in at least one other of the modules.

9. The apparatus according to claim 3 wherein the optical interface of the wavelength division multiplexing optical line termination unit in one of the modules is arranged to use the same set of wavelength channels as the wavelength division multiplexing optical line termination unit in another of the modules.

10. The apparatus according to claim 1 further comprising network interface apparatus for interfacing with an operator network.

11. The apparatus according to claim 10 wherein the network interface apparatus comprises at least one of: apparatus to multiplex traffic, and apparatus to compress traffic.

12. A network node comprising apparatus according to claim 1.

13. A method of installing an optical access network, the method comprising:
installing an apparatus at a node of the optical access network, the apparatus comprising:
wavelength division multiplexing optical line termination apparatus comprising an optical interface for interfacing with a plurality of remote optical network units in a passive optical network using a plurality of wavelength channels, and a plurality of electrical first ports corresponding to the optical wavelength channels;
a plurality of second ports for interfacing with at least two operator networks; and
an electrical switching matrix for interconnecting the first ports and the second ports; and
for each optical network unit of the passive optical network requiring connection, configuring the switching matrix to interconnect a first port, corresponding to an optical wavelength channel used by that optical network unit, and a second port corresponding to a required operator network for that optical network unit.

14. The method according to claim 13,
wherein the wavelength division multiplexing optical line termination apparatus comprises a plurality of optical interfaces, each for interfacing with a plurality of remote optical network units in a different passive optical network using a plurality of wavelength channels, there being a plurality of electrical first ports corresponding to the optical wavelength channels used in each optical interface;
wherein the apparatus comprises a plurality of modules, wherein each of the modules comprises a wavelength division multiplexing optical line termination unit which provides one of the optical interfaces and has a plurality of electrical first ports corresponding to the optical wavelength channels used in that optical interface;
and wherein the method further comprises:
installing an additional module to the apparatus, the additional module comprising an optical interface for interfacing with additional remote optical network units;
for each additional optical network unit requiring connection, configuring the switching matrix unit in the additional module to interconnect a first port, corresponding to an optical wavelength channel used by that optical network unit, and a second port corresponding to a required operator network for that optical network unit.

15. A method of upgrading an optical access network comprising an apparatus at a node of the optical access network, the apparatus comprising:
wavelength division multiplexing optical line termination apparatus comprising an optical interface for interfacing with a plurality of remote optical network units in a passive optical network using a plurality of wavelength channels, and a plurality of electrical first ports corresponding to the optical wavelength channels;
a plurality of second ports for interfacing with at least two operator networks; and
an electrical switching matrix for interconnecting the first ports and the second ports;
wherein the switching matrix is configured to interconnect a first port, corresponding to an optical wavelength channel used by an optical network unit, and a second port corresponding to a first operator network for that optical network unit,
and wherein the method comprises:
reconfiguring the switching matrix to interconnect the said first port, corresponding to the optical wavelength channel used by the optical network unit, and another second port corresponding to a different required operator network for that optical network unit.

16. The method according to claim 15 wherein the apparatus comprises a plurality of modules, wherein each of the modules comprises a wavelength division multiplexing optical line termination unit which provides one of the optical interfaces and has a plurality of electrical first ports corresponding to the optical wavelength channels used in that optical interface;
and wherein the method further comprises:
installing an additional module to the apparatus, the additional module comprising an optical interface for interfacing with additional remote optical network units and additional electrical first ports;
for each additional optical network unit requiring connection, configuring the switching matrix unit in the additional module to interconnect a first port, corresponding to an optical wavelength channel used by that optical network unit, and a second port corresponding to a required operator network for that optical network unit.
